(19) United States
(12) Patent Application Publication
(10) Pub. No.: US 2011/0232397 A1
(43) Pub. Date: Sep. 29, 2011

(54) AUTOMATED ANALYSIS DEVICE WITH AN AUTOMATIC PIPETTING DEVICE AND WITH TWO PUMPING UNITS OF DIFFERENT CAPACITIES

(75) Inventor: Roland SCHENK, Kirchheim (DE)

(73) Assignee: Diasys Technologies s.a.r.l, Clapiers (FR)

(21) Appl. No.: 13/129,627

(22) PCT Filed: Nov. 16, 2009
(86) PCT No.: PCT/EP2009/065250

§ 371 Date: May 17, 2011

(30) Foreign Application Priority Data
Nov. 18, 2008 (DE) 10 2008 058 063.5

(51) Int. Cl. B01L 3/02

(52) U.S. Cl. 73/864.13

(57) ABSTRACT

The invention relates to an automatic pipetting device, which comprises at least two pumping units of different capacities and a liquid line, said liquid line opening on one side into a rinsing liquid reservoir and on the other side into a pipetting needle. In order for one pumping unit to be able to execute a pipetting cycle with small volumes at high stroke resolution and the other pumping unit to be able to execute a rinse cycle with large volumes, and to make the pumping units as space-saving, as low-maintenance and as inexpensive as possible, it is proposed according to the invention to drive the pistons of the at least two pumping units synchronously by a piston drive device and to arrange the point at which the largest working chamber is connected to the liquid line closer to the rinsing liquid reservoir than the point at which the working chamber of the at least one other pumping unit is connected to the liquid line, wherein moreover a 3-way valve is arranged on the liquid line at the point at which the largest working chamber is connected to the liquid line.

The present invention relates to an automatic pipetting device for a device for the automated analysis of liquids, wherein the pipetting device comprises at least two pumping units of different capacities and a liquid line, wherein the pumping units each have a cavity, in each of which a piston is arranged axially movable, wherein each piston delimits, with the cavity in which the piston is arranged, a working chamber, whose volume varies with the axial position of the piston, wherein the pistons are moved axially by means of a piston drive device, wherein each working chamber is connected to a liquid line, wherein the liquid line opens into a rinsing liquid reservoir on one side and has a transition to a pipetting needle on the other side. Furthermore, the present invention relates to an automated analysis device with said automatic pipetting device.

Within the scope of increasing automation in the area of human and veterinary medical diagnostics, among other things, devices have been developed for the automated analysis of liquids, so-called analysers, which can take the various reagents required for carrying out an analysis from reagent containers and combine them with a sample for the purpose of carrying out the analysis in a reaction vessel. For this, the analysers often have a carousel in which either receiving zones for reagent containers or receiving zones for sample containers are provided. In special analyser carousels, receiving zones for reagent containers and receiving zones for sample containers are both provided. These carousels are usually driven by a driving mechanism provided in the analyser to perform a rotary movement of the carousel.

The reagent or sample is usually removed and transferred to a reaction vessel by an automatic pipetting device. As a rule said automatic pipetting device comprises a pipetting arm, on which a pipetting needle is arranged, which is connected to a pumping unit with which a liquid can be drawn into the pipetting needle and can also be expelled again from the pipetting needle. Said pipetting arm is as a rule designed so that, by means of the pipetting arm, the pipetting needle can be moved over a working zone, in which working zone the reagent containers, sample containers and/or reaction vessels (e.g. cuvettes) are arranged stationary or are made available temporarily, e.g. by a carousel.

Between the individual pipetting operations, it is regularly necessary to clean the inside and outside of the pipetting needle of the automatic pipetting device. For this, generally the pipetting needle is dipped in a rinsing liquid, wherein a certain amount of rinsing liquid is drawn into the pipetting needle. Then the pipetting needle is ejected from the rinsing liquid and emptied over a waste container or a drain and is left to drain off or is wiped.

Furthermore, analysers often comprise at least one control unit for controlling the movements of the pipetting arm, of the pumping unit, of the pipetting needle, of the lifting column and/or of the carousel, a measuring device for determining a physical or chemical quantity of a reaction mixture placed in a reaction vessel and a data processing device for initializing and executing an analysis program and for the processing and output of a measured physical or chemical quantity.

As already described, the inside and outside of the pipetting needle of the automatic pipetting device must usually be cleaned between the individual pipetting operations. One possibility for cleaning consists of dipping the pipetting needle into a rinsing liquid and drawing a suitable amount of rinsing liquid into the pipetting needle. After the pipetting needle has been brought above a waste container or a drain, the rinsing liquid can then be expelled from the pipetting needle. In alternative designs, the rinsing liquid is not drawn up by means of the pipetting needle, but by means of a pumping unit connected to the pipetting needle, which can draw in the rinsing liquid from a rinsing liquid reservoir and discharge it through the pipetting needle. This at least cleans the inside of the pipetting needle. In this approach the outside of the pipetting needle can be cleaned either by wiping, or in some other way.

In both cases it is necessary that the pumping unit can execute both a pipetting cycle with as a rule very small volumes in the range from 1 μl to 500 μl as well as rinse cycles with volumes of about 1 ml to 2 ml or more of rinsing liquid.

Sometimes these pump devices are provided with two motor drives, wherein one of the two motor drives serves for actuating a metering syringe, and the other serves for driving a pump which is intended for injection of the rinsing liquid. Typically the metering syringe, which is designed for small volumes, has an insufficient piston displacement to be able to execute a rinse cycle promptly as well.

These pumping units are of very expensive construction, have a large number of moving wearing parts and take up a relatively large amount of room in an analyser. In particular the driving mechanisms for the syringe are liable to wear, in particular the gear unit, which is responsible for transmission of force from the motor to the piston.

Therefore there is a demand for an automatic pipetting device for an analyser, which is less susceptible to wear and accordingly has a longer service life and which nevertheless is able to perform pumping operations with very varied volumes as accurately as possible.

Therefore the problem to be solved by the present invention is to provide an automatic pipetting device for an analyser, wherein the pipetting device has at least two pumping units of different capacities, with one of the pumping units being able to execute a pipetting cycle with small volumes in the range from about 1 pl to 500 μl with a stroke resolution that is as high as possible and the other pumping unit being able to execute a rinse cycle with volumes in the range from about 500 to 5000 μl. The pumping units should if possible be of a design such that they occupy little space in the analyser.

This problem is solved according to the invention with an automatic pipetting device of the type stated at the outset, in which the pistons of the at least two pumping units are moved axially synchronously by a piston drive device and wherein the point at which the largest working chamber is connected to the liquid line is closer to the rinsing liquid reservoir than the point at which the working chamber of the at least one other pumping unit is connected to the liquid line, wherein a 3-way valve is arranged on the liquid line at the point at which the largest working chamber is connected to the liquid line. If several pumping units are provided, the largest pumping unit is connected closer on the rinsing liquid reservoir to the liquid line than all other pumping units.

Here, pump capacity means the maximum piston displacement. Accordingly, the at least two pumping units of the pipetting device according to the invention have different maximum piston displacements.

The automatic pipetting device according to the present invention basically requires only the one valve as described, which is provided at the point described. However, the present invention also comprises pipetting devices in which additional valves are arranged between the rinsing liquid reservoir and the pipetting needle along the liquid line or along lines connected to the liquid line. In a preferred embodiment, however, no additional valve or at most one additional valve is arranged on the liquid line between the rinsing liquid reservoir and the pipetting needle.

Three-way valves are valves with three connections and various switching positions. Two of the three connections of the valve are connected to the liquid line and the third connection is connected to the working chamber of the largest pumping unit. Basically all 3-way valves known to a person skilled in the art are suitable in connection with the present invention. Expediently the valves are controlled globe valves. Particularly preferably, however, the valves used are solenoid valves.

Preferably, the 3-way valve is provided at least with the switching positions at which, in the liquid line between rinsing liquid reservoir and pipetting needle, a) flow is interrupted between the point at which the largest working chamber is connected to the liquid line, and the rinsing liquid reservoir, and flow is possible between the point at which the largest working chamber is connected to the liquid line, and the pipetting needle, and b) flow is interrupted between the point at which the largest working chamber is connected to the liquid line, and the pipetting needle, and flow is possible between the point at which the largest working chamber is connected to the liquid line, and the rinsing liquid reservoir. Preferably, the 3-way valve is a 3/2-way valve with the switching possibilities described in the preceding paragraph.

Preferably the 3-way valve according to the present invention and optionally at most one other valve provided on the liquid line and the piston drive device are controlled by electronic control elements. For example, control can be provided by a processor.

The advantage of the present invention is that two pumping units of different capacities are provided in an automatic pipetting device in an extremely space-saving manner. The space saving is possible because the at least two pumping units can be moved axially synchronously by a common piston drive device. Another advantage of the invention is that to make alternating execution of pipetting and rinse cycles possible, basically only one valve has to be arranged in the region of the liquid line. This is achieved by the use of a 3-way valve, which is arranged at a correspondingly suitable point. As only one valve needs to be used, the pipetting device according to the invention has relatively few moving and wearing parts. At the end of the life of the one valve provided, just one valve has to be replaced, and not several valves, as is usually necessary with pipetting devices of the state of the art.

In a preferred embodiment, the cavities of the at least two pumping units are made in one and the same single-piece block of material. The block of material can for example consist of an acrylic glass body with corresponding holes.

Preferably the piston drive device comprises a motor, which drives a pinion, which engages with a gear wheel that is connected to a driving element, and said driving element is connected to the piston. If the pinion is turned by the motor, this leads to a synchronous axial movement of the piston in the cavities of the pumping units.

In a preferred embodiment, the working chambers of the pumping units converge at a point in the direction of a connecting line which joins the working chambers to the liquid line. Even more preferably, the pistons arranged in these working chambers are also made correspondingly narrower.

To maximize the service life of the pistons, particularly preferably displacement pistons are used which are not sealed against the cylinder wall, but are only sealed at the entry point in the bottom of the cylinder. With this type of cylinder, the swept volume corresponds to the volume of the part of the piston that this occupies in the working chamber. As the tolerances are somewhat larger with these pistons, they are somewhat less expensive. Displacement pistons made of ceramic or high-alloy high-grade steel (e.g. stainless steel) are particularly preferred.

Preferably the piston displacement of the largest pumping unit is in the range from 500 to 5000 μl. The piston displacement of the smallest pumping unit is preferably in the range from 50 to 500 μl.

The piston displacement ratio between the at least two pumping units of the pipetting device is preferably in the range from 20:1 to 10:1. In particularly preferred embodiments the pipetting device has two pumping units, one of which has a piston displacement of 2250 μl and the other ha s a piston displacement of 250 μl. In another preferred embodiment the piston displacement of one pumping unit is 2375 μl and the piston displacement of the other pumping unit is 125 μl.

The stroke resolution of the smallest pumping unit is preferably in the range from 0.01 μl/step to 0.1 μl/step. The stroke resolution of the largest pumping unit is preferably in the range from 0.5 μl/step to 2 μl/step. The pipetting device according to the invention can advantageously be operated in such a way that always only rinsing liquid, e.g. water, enters the working chambers of the pumping units, and never sample or reagent liquid that was drawn into the pipetting needle.

As already mentioned initially, the device according to the invention with the liquid container carousel as described has one or more of the following elements: a drive device for the carousel, a pipetting device, a rinsing station, a device producing heat, a device producing cold, an optical measuring device for determining a physical or chemical quantity of the reaction mixture and an optoelectronic reading device for reading an optoelectronically readable code, which is applied on the carousel or carousels and/or on the samples and/or reagents.

For purposes of original disclosure, it is pointed out that all features, as will be apparent to a person skilled in the art from the present description, the drawings and the claims, even if they have only been described specifically in connection with certain other features, can be combined both individually and in any combinations with other features or groups of features disclosed here, provided that this has not been expressly excluded or technical circumstances make such combinations impossible or meaningless. Comprehensive, explicit presentation of all conceivable combinations of features is only omitted here for the sake of brevity and readability of the description.

Other features or groups of features and examples of possible conceivable combinations of features are disclosed or illustrated by the following description of the appended drawings.

There are shown in:

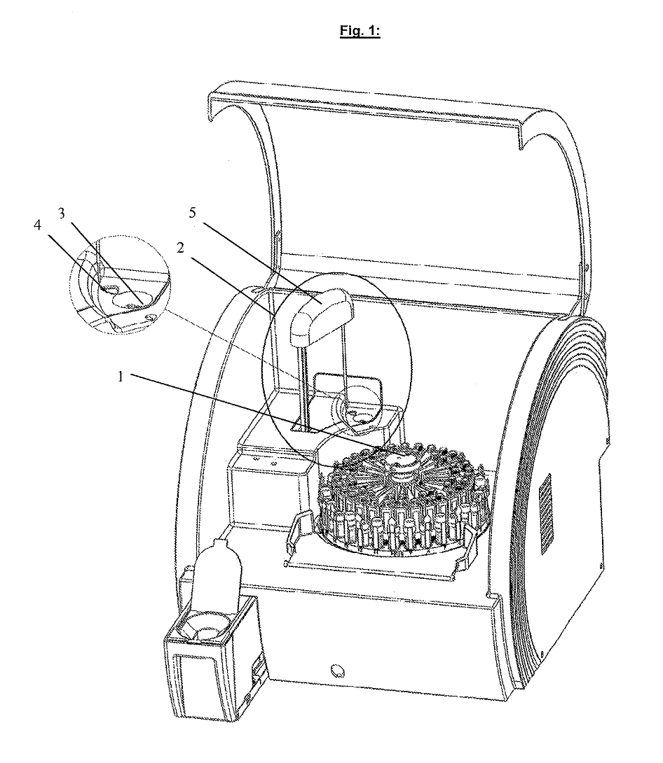

FIG. 1 a device for the automated analysis of liquids (analyser) with a pipetting device according to the present invention,

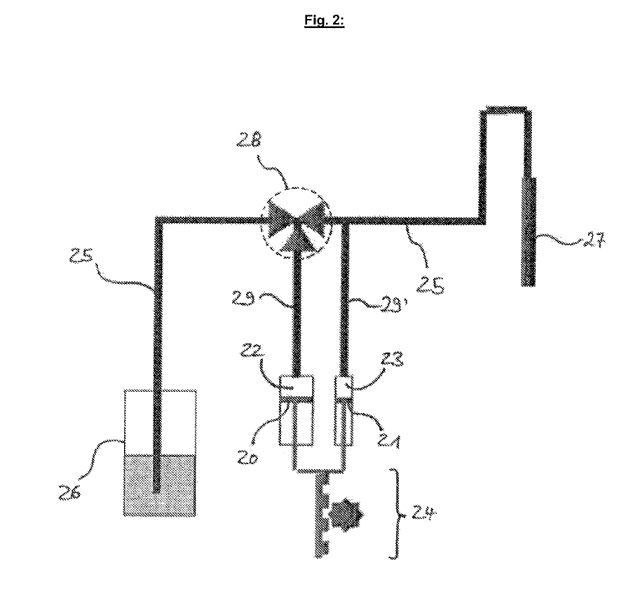

FIG. 2 a schematic representation of the pumping units of the pipetting device according to the invention,

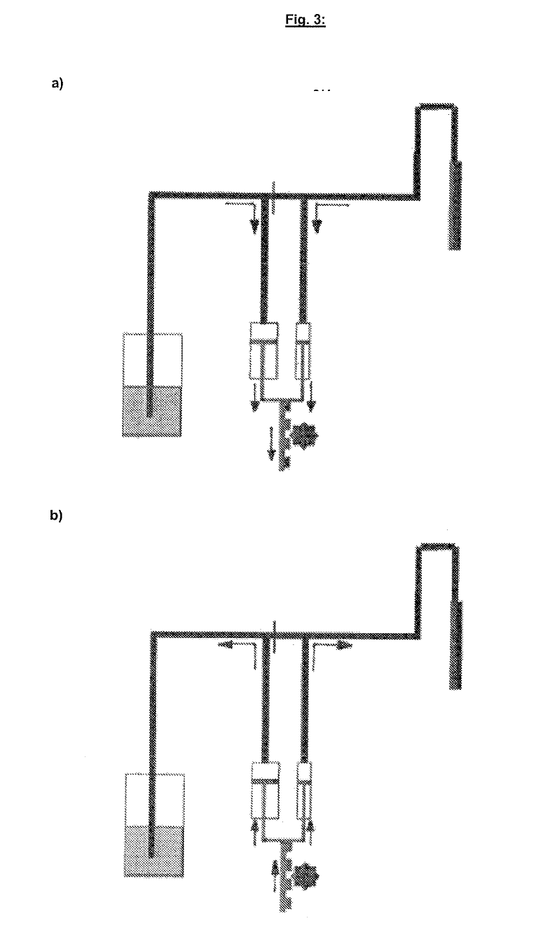

FIG. 3 a schematic representation of the pumping units of the pipetting system according to the invention during the pipetting operation and

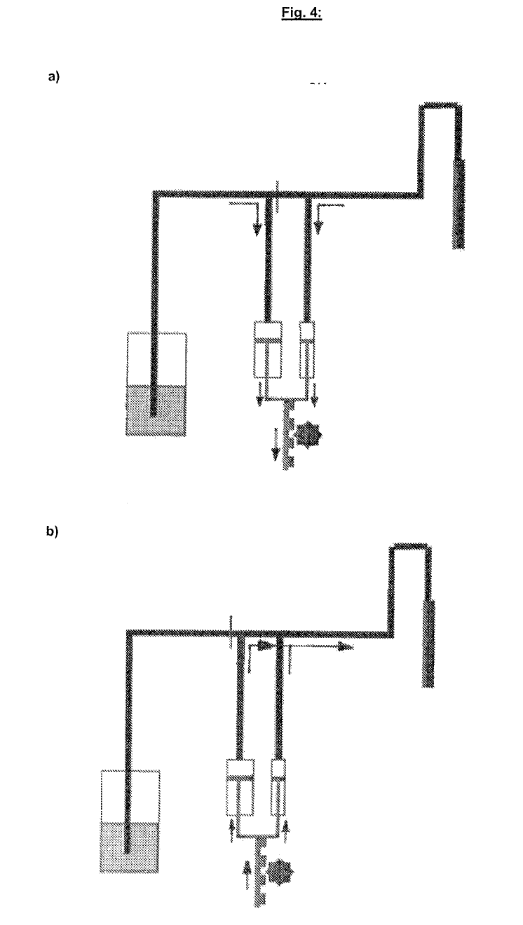

FIG. 4 a schematic representation of the pumping units of the pipetting system according to the invention during the rinsing operation.

FIG. 1 shows a device for the automated analysis of liquids (analyser), which has a carousel 1 for liquid containers and a pipetting device 2 with a pipetting arm 5. The carousel 1 is arranged in such a way that it can move the liquid containers into the working zone of the pipetting arm 5. Furthermore, a rinsing station 3 and a measuring device 4 for determining the exact position of the tip of the pipetting needle are also provided in the working zone of the pipetting arm 5.

FIG. 2 shows a schematic representation of a pipetting system according to the invention with two pumping units of different capacities. The pumping units consist of pistons 20, 21, which are arranged movably axially in a cavity. The two pistons 20, 21 delimit, in conjunction with the cavity, in each case a working chamber 22, 23, whose volume varies with the axial position of the piston 20, 21. The left piston 20 is a large piston, which moves in a correspondingly large cavity and thus delimits a correspondingly large working chamber 22. The right piston 21 is a small piston which, in a correspondingly small cavity, delimits a correspondingly small working chamber 23. The two pistons 20, 21 are moved axially synchronously by means of a piston drive device 24. The two working chambers 22, 23 are connected by connecting lines 29, 29′ to a liquid line 25. On one side, the liquid line 25 opens into a rinsing liquid reservoir 26. On the other side, the liquid line 25 has a transition to a pipetting needle 27.

The point at which the larger working chamber 22 is connected to the liquid line 25 is closer to the rinsing liquid reservoir 26 than the point at which the smaller working chamber 23 is connected to the liquid line 25. In addition, a 3/2-way valve 28 is arranged at the point at which the larger working chamber 22 is connected to the liquid line 25. FIGS. 3a) and b) show the piston movements and the directions of flow of the liquids in the liquid lines during a pipetting operation. It can be seen from FIG. 3a) that the piston drive device performs a movement, which results in both pistons moving downwards. There is a corresponding increase in the volume of the working chambers, with the result that liquid is drawn into the working chambers via the connecting lines.

In this phase of the pipetting operation, the 3-way valve is switched so that, in the liquid line between rinsing liquid reservoir and pipetting needle, flow between the point at which the largest working chamber is connected to the liquid line, and the pipetting needle is interrupted, and flow between the point at which the largest working chamber is connected to the liquid line, and the rinsing liquid reservoir is possible. If the larger piston moves downwards, so that the volume of the larger working chamber increases, only rinsing liquid is drawn into the larger working chamber from the branch of the liquid line between the larger working chamber and the rinsing liquid reservoir. On the other hand, owing to the increase in volume of the smaller working chamber, the liquid in the branch of the liquid line that is between the point at which the smaller working chamber is connected to the liquid line, and the pipetting needle, is drawn into the smaller working chamber, making it possible for a corresponding volume of a sample or of a reagent to be drawn into the pipetting needle.

In the second phase of the pipetting operation shown in FIG. 3b), the valve remains in the position as described for FIG. 3a). However, the piston drive device moves in the opposite direction, so that the large and the small piston move synchronously towards the liquid outlets into which the working chambers open, wherein the corresponding working chambers of the two pumping units becomes smaller, which in the case of the large working chamber has the result that the rinsing liquid present in this working chamber is pumped back towards the rinsing liquid reservoir. On the other side of the liquid line, a volume of sample or reagent is expelled from the pipetting needle, corresponding to the volume by which the volume of the smaller working chamber is reduced.

FIGS. 4a) and 4b) show the processes that take place in a rinsing operation. In the phase shown in FIG. 4a), the pistons are moved downwards synchronously. The valve position corresponds to the position as was described for FIGS. 3a) and 3b). Accordingly, owing to the downward movement of the pistons, once again rinsing liquid is drawn from the rinsing liquid reservoir into the left working chamber and rinsing liquid from the right branch of the liquid line is drawn into the smaller working chamber.

In the second phase of the rinsing operation, shown in FIG. 4b), the position of the valve is different from the valve position described previously. In this phase the valve is switched so that in the liquid line between rinsing liquid reservoir and pipetting needle, flow between the point at which the largest working chamber is connected to the liquid line, and the rinsing liquid reservoir is interrupted, and flow between the point at which the largest working chamber is connected to the liquid line, and the pipetting needle is possible. If the two pistons now move upwards, rinsing liquid is pumped from both working chambers through the branch of the liquid line that goes towards the pipetting needle and is expelled through the pipetting needle opening. With a suitable volume of the larger working chamber and corresponding volume of the liquid line between the larger working chamber and the tip of the pipetting needle, in this way the pipetting needle can be rinsed completely.

In all pipetting operations it is necessary to ensure that a sufficiently large air bubble is always present between the volume of reagent or sample drawn into the pipetting needle and the rinsing liquid present in the liquid line 25, so that the liquid drawn into the pipetting needle cannot come into contact with the rinsing liquid contained in the liquid line. For this, after each rinsing operation some ambient air is drawn into the pipetting needle before the sample or reagent is taken up.

### REFERENCE NUMBERS

1 Carousel for liquid containers

2 Pipetting device

3 Rinsing station

4 Capacity measuring device

5 Pipetting arm

20 Large piston

21 Small piston

22 Large working chamber

23 Small working chamber

24 Piston drive device

25 Liquid line

26 Rinsing liquid reservoir

27 Pipetting needle

28 3-Way valve

29 Connecting line

1. Automatic pipetting device for a device for the automated analysis of liquids, wherein the pipetting device comprises at least two pumping units of different capacities and a liquid line, wherein the pumping units each have a cavity, in each of which a piston is arranged axially movable, wherein each piston delimits, with the cavity in which the piston is arranged, a working chamber, whose volume varies with the axial position of the piston, wherein the pistons are moved axially synchronously by a piston drive device, wherein each working chamber is connected to a liquid line, and on one side said liquid line opens into a rinsing liquid reservoir and on the other side it has a transition to a pipetting needle, wherein the point at which the largest working chamber is connected to the liquid line is closer to the rinsing liquid reservoir than the point at which the working chamber of the at least one other pumping unit is connected to the liquid line, wherein a 3-way valve is arranged on the liquid line at the point at which the largest working chamber is connected to the liquid line.

2. Pipetting device according to claim 1, wherein the 3-way valve is a 3/2-way valve.

3. Pipetting device according to claim 1, wherein no valve or at most one other valve is arranged on the liquid line between the rinsing liquid reservoir and the pipetting needle.

4. Pipetting device according to claim 1, wherein the 3-way valve and optionally the at most one other valve and the piston drive device are controlled by electronic control elements.

5. Pipetting device according to claim 1, wherein the cavities of the at least two pumping units are made in the same single-piece block of material.

6. Pipetting device according to claim 1, wherein the piston drive device comprises a motor, which drives a pinion, which engages non-positively in a rack of a driving element, said driving element being connected to the pistons, wherein a movement of the pinion leads to a synchronous axial movement of the pistons in the cavities of the pumping units.

7. Pipetting device according to claim 1, wherein the upper end of at least one of the cavities and/or the upper end of at least one of the pistons converge upwards to a point, wherein this upper end of the cavity opens into a connecting line, which connects the cavity to the liquid line.

8. Pipetting device according to claim 1, wherein the piston displacement of the largest pumping unit is in the range from 500 to 5000 μl and/or the piston displacement of the smallest pumping unit is in the range from 50 to 500 μl.

9. Pipetting device according to claim 1, wherein the pipetting device has two pumping units with a piston displacement ratio in the range from 20:1 to 10:1.

10. Pipetting device according to claim 1, wherein the stroke resolution of the smallest pumping unit is in the range from 0.01 μl/step to 0.1 μl/step and/or the stroke resolution of the largest pumping unit is in the range from 0.5 μl/step to 2 μl/step.

11. Automated analysis device with a pipetting device according to claim 1 and with one or more of the following elements: an analysis rotor, a rinsing station, a device producing heat, a device producing cold, an optical measuring device and an optoelectronic reading device for reading an optoelectronically readable code.
